(19) United States
(12) Patent Application Publication
(10) Pub. No.: US 2011/0308413 A1
(43) Pub. Date: Dec. 22, 2011

(54) RADIALLY EXTENSIBLE, SLEEVE-SHAPED PRINTING BLANKET AND METHOD FOR PRODUCING SUCH A PRINTING BLANKET

(75) Inventors: Christian Sameit, Bonstetten (DE); Eduard Hoffmann, Bobingen (DE); Thomas Kandlbinder, Augsburg (DE); Georg Schmid, Neusaess (DE)

(73) Assignee: manroland AG, Offenbach/Main (DE)

(21) Appl. No.: 13/140,800

(22) PCT Filed: Dec. 15, 2009
(86) PCT No.: PCT/EP09/08958

§ 371 Date: Sep. 6, 2011

(30) Foreign Application Priority Data
Dec. 18, 2008 (DE) 10 2008 054 861.8

(51) Int. Cl. B41C 3/08

(52) U.S. Cl. 101/401.1

(57) ABSTRACT

A printing blanket for fastening on a printing blanket cylinder and a method for the production thereof are disclosed. The printing blanket includes at least one inner carrier layer, a first intermediate layer designed as a woven fabric layer and an outer cover layer. The woven fabric layer includes warp threads and weft threads. The printing blanket can be fastened on a printing blanket cylinder such that the warp threads extend in the axial direction of the printing blanket cylinder and the weft threads extend in the circumferential direction of the printing blanket cylinder.

This application claims the priority of International Application No. PCT/EP2009/008958, filed Dec. 15, 2009, and German Patent Document No. 10 2008 054 861.8, filed Dec. 18, 2008, the disclosures of which are expressly incorporated by reference herein.

### BACKGROUND AND SUMMARY OF THE INVENTION

The invention relates to a radially extensible, sleeve-shaped printing blanket and a method for producing a printing blanket, wherein the printing blanket comprises at least one inner carrier layer, an intermediate layer designed as a woven fabric layer and an outer cover layer.

Printing blankets are sufficiently known from the prior art. Reference is made in this regard to the following documents: U.S. Pat. No. 3,652,376, U.S. Pat. No. 3,700,541, U.S. Pat. No. 4,042,743, U.S. Pat. No. 4,770,928, GB 2,016,373, EP 0 452 184 and U.S. Pat. No. 6,386,100.

EP 1 268 218 B1 describes another class of printing blankets than the present invention, namely a flat image transfer rubber blanket with a non-extensible base layer in the form of a flat metal plate, which can be clamped with its ends in a clamping gap of a printing blanket cylinder. Because of their non-extensibility, these types of printing blankets have distinctly different material properties than radially extensible sleeve-shaped printing blankets and they also have a distinctly different spatial-geometric structure. EP 1 268 218 B1 states in column 4 that it is not feasible to mount a conventional woven fabric printing blanket on a non-extensible metal base layer, because the thereby resulting printing blanket is extremely difficult to manipulate and brace.

Woven fabric layers are produced in that warp threads, which as a rule are arranged parallel to one another, are fixed in the longitudinal direction of the woven fabric material web to be produced or otherwise provided in a suitable manner and then weft threads are inserted between the warp threads, as a rule after mutual, spatial offsetting of at least one portion of the warp threads, as a rule in a direction perpendicular to the woven fabric material web, in order to produce the interweaving of the woven fabric. As a result, such a woven fabric layer is normally automatically aligned in such a way that the warp threads are arranged in the longitudinal direction of the material web and the weft threads are arranged in a direction transverse to the material web. Warp threads and weft threads thereby have different material properties. Thus, the warp threads as a rule are suitably reinforced due to the assumed higher mechanical load of woven fabrics in order to be able to withstand these higher mechanical loads. Woven fabrics are thus inhomogeneous with respect to their material properties, and thus have different material properties in the direction of the warp threads than in the direction of the weft threads.

The same applies to printing blanket material webs which contain woven fabric layers. Normally a printing blanket material web already has the desired expansion that is required for the expansion of a printing blanket in the axial direction of a printing blanket cylinder, which is supposed to be equipped with the printing blanket. Therefore, until now partial sections of the printing blanket material web have been cut off, whose length corresponds in the longitudinal direction of the material web to the circumferential length of the printing blanket cylinder to be equipped so that the warp threads of the woven fabric layer of the printing blanket are automatically arranged on the printing blanket cylinder in the circumferential direction of the printing blanket cylinder. This is depicted in FIGS. 1, 2 and 8.

However, it has surprisingly turned out that such a printing blanket arrangement still has certain disadvantages with respect to the web transport of a paper web in a printing press, and similarly the registerability of the printing blanket is also not optimal.

Therefore, the object of the present invention is eliminating the aforementioned disadvantages.

A first subject matter of the invention relates to a printing blanket for fastening on a printing blanket cylinder, comprising at least one inner carrier layer, a first intermediate layer designed as a woven fabric layer and an outer cover layer, wherein the woven fabric layer comprises warp threads and weft threads. It is provided according to the invention that the printing blanket can be fastened on the printing blanket cylinder such that the warp threads extend in the axial direction of the printing blanket cylinder and the weft threads extend in the circumferential direction of the printing blanket cylinder. The printing blanket is designed as a sleeve-shaped printing blanket, which can be slid in the form of a cylinder over the printing blanket cylinder. For this purpose, the printing blanket is designed to be radially extensible in such a way that this printing blanket can be widened by radial expansion in order to slide the printing blanket onto the printing blanket cylinder and then it can be shrunk onto the printing blanket cylinder by lessening the radial expansion.

Optimized properties of the printing blanket with respect to web transport and registerability may be achieved through this unusual, but advantageous arrangement according to the invention, in which the warp threads are arranged in the axial direction of the printing blanket cylinder and the weft threads are arranged in the circumferential direction. As already stated, the warp threads as a rule are suitably reinforced due to the assumed higher mechanical load of woven fabrics in order to be able to withstand these higher mechanical loads. Conversely, the arrangement of the weft threads, which have a lower mechanical stability, in the circumferential direction of the cylinder favors a radial extensibility of sleeve-shaped printing blankets. The fact that these types of woven fabrics are inhomogeneous with respect to their material properties, namely that they have different material properties in the direction of the warp threads than in the direction of the weft threads, is thus utilized advantageously in the case of the present invention precisely to realize radially extensible, sleeve-shaped printing blankets.

It is thereby especially provided that the expansion of the woven fabric layer or of the entire printing blanket in the direction of the warp threads is greater than in the direction of the weft threads. This type of printing blanket may especially preferably have an expansion greater than 2.5 m in the direction of the warp threads. This is rendered possible especially by the increased mechanical stability of the warp threads.

In addition, it may be provided that the carrier layer is designed as a metal layer or a plastic layer or a woven fabric layer or even as a combination of these aforementioned material layers.

The carrier layer is designed in particular in such a way that it permits an operationally reliable mounting of the printing blanket on the printing blanket cylinder, but may additionally have a supporting and stabilizing, especially shape-stabilizing effect such as is the case, for example, with metal carrier layers or plastic carrier layers due to the rigidity of the material.

It may further be provided that a second intermediate layer designed as a compressible layer is arranged between the carrier layer and the woven fabric layer described above.

A further subject matter of the invention is a printing couple for a web-fed printing press, comprising at least:

one plate cylinder with a printing plate, which has at least 96 printed pages,

a printing blanket cylinder with a printing blanket, comprising at least one inner carrier layer, a first intermediate layer designed as a woven fabric layer and an outer cover layer, wherein the woven fabric layer comprises warp threads and weft threads,

wherein the printing blanket can be fastened on the printing blanket cylinder such that the warp threads extend in the axial direction of the printing blanket cylinder and the weft threads extend in the circumferential direction of the printing blanket cylinder. The printing blanket is designed as a sleeve-shaped printing blanket, which can be slid in the form of a cylinder over the printing blanket cylinder. For this purpose, the printing blanket is designed to be radially extensible in such a way that this printing blanket can be widened by radial expansion in order to slide the printing blanket onto the printing blanket cylinder and then it can be shrunk onto the printing blanket cylinder by lessening the radial expansion.

Within the scope of the printing couple according to the invention, this printing blanket may be further developed in a manner analogous to the printing blanket according to the invention described above, i.e., it may also possess the aforementioned features of the printing blanket individually or as a combination thereof.

A further subject matter of the present invention is a method for producing a printing blanket, which is designed for fastening on a printing blanket cylinder and which comprises at least:
one inner carrier layer,
a first intermediate layer designed as a woven fabric layer,
an outer cover layer,
wherein the woven fabric layer comprises warp threads and weft threads,
characterized in that a printing blanket section is removed from a printing blanket material web in such a way that the expansion of the printing blanket section in the longitudinal direction of the printing blanket material web is greater than the expansion in the transverse direction of the printing blanket material web.

An exemplary embodiment of the present invention will be described in the following on the basis of FIGS. 1 to 8.

### BRIEF DESCRIPTION OF THE DRAWINGS

FIG. 1 illustrates a printing blanket arrangement according to the prior art;

FIG. 2 is an enlarged partial section of FIG. 1;

FIG. 3 illustrates a printing blanket arrangement according to the invention;

FIG. 4 is an enlarged partial section of FIG. 3;

FIG. 5 illustrates a printing blanket arrangement according to the invention on a printing blanket cylinder;

FIG. 6 is an enlarged partial section of FIG. 5;

FIG. 7 is an enlarged schematic sectional representation of a printing plate with 96 printed pages; and

FIG. 8 is an enlarged schematic representation of a printing blanket material web.

### DETAILED DESCRIPTION OF THE DRAWINGS

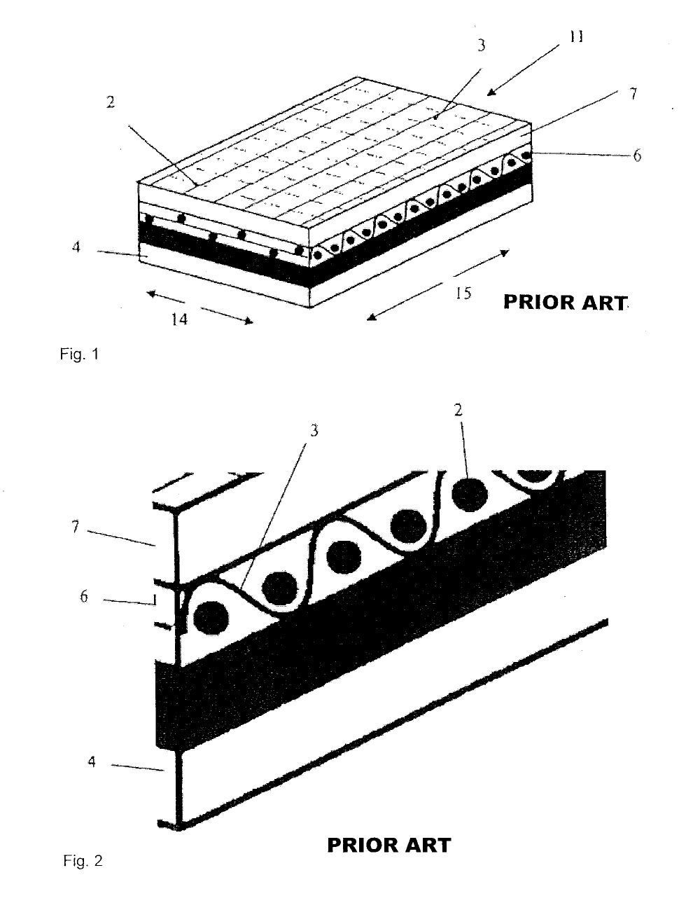

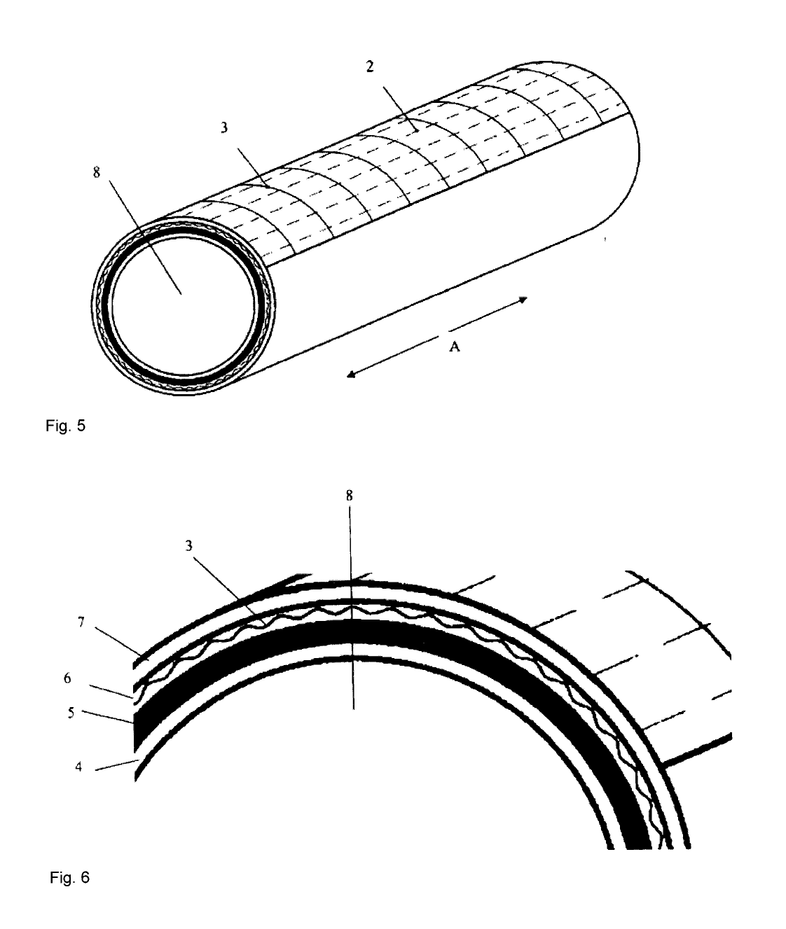

FIGS. 1 and 2 show a printing blanket 11 according to the prior art, which is designed for fastening on a printing blanket cylinder 8. This printing blanket 11 comprises: an inner carrier layer 4, a first intermediate layer designed as a woven fabric layer 6 and an outer cover layer 7, wherein the woven fabric layer 6 comprises warp threads 2 and weft threads 3. According to the prior art, this printing blanket 11 can be fastened on a printing blanket cylinder 8 (as shown by way of example in FIG. 5) such that the warp threads 2 extend in the circumferential direction of the printing blanket cylinder 8 and the weft threads 3 extend in the axial direction of the printing blanket cylinder 8.

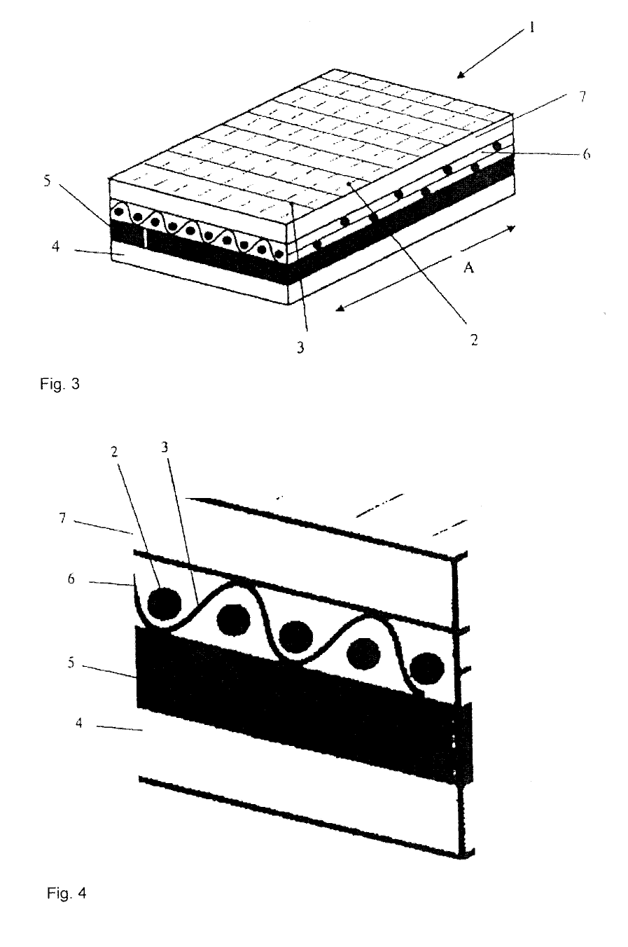

In contrast, FIGS. 3 and 4 show a printing blanket 1 according to the invention, which is also designed for fastening on a printing blanket cylinder 8. FIGS. 5 and 6 show how this printing blanket is fastened according to the invention on the printing blanket cylinder 8. The printing blanket likewise comprises: an inner carrier layer 4, a first intermediate layer designed as a woven fabric layer 6 and an outer cover layer 7, wherein the woven fabric layer 6 comprises warp threads 2 and weft threads 3. According to FIGS. 3 and 4, however, the printing blanket can be fastened on the printing blanket cylinder 8 depicted in FIG. 5 such that the warp threads 2 extend in the axial direction A of the printing blanket cylinder 8 and the weft threads 3 extend in the circumferential direction of the printing blanket cylinder 8. For reasons of simplicity, FIG. 5 shows only the weft threads 3 in cross section, which are also identifiable in the enlarged section in FIG. 6. In fact, however, the cross section is designed as shown in FIG. 4 such that the weft threads 2 are woven between the warp threads 3. Thus, FIG. 4 shows most clearly the details in cross section through the printing blanket 1 on the printing blanket cylinder 8; FIG. 4 thus represents a further enlargement of the cross-sectional representation of FIGS. 5 and 6.

The expansion of the woven fabric layer 6 is greater in the direction of the weft threads 3 than in the direction of the warp threads 2. The carrier layer 4 is designed either as a metal layer, e.g., as a metal backing in the case of so-called sleeve-shaped printing blankets or sleeve printing blankets. The carrier layer 4 may also be designed as a plastic layer or a similar rigid, preferably incompressible layer. Alternatively, the carrier layer 4 may also be designed as an especially reinforced, for example, shape-stabilizing woven fabric layer. The printing blanket 1 is designed as a sleeve-shaped, cylindrical printing blanket.

A second intermediate layer designed as a compressible layer 5 may preferably be arranged between the carrier layer 4 and the woven fabric layer 6. Even more layers than those depicted may be provided, in particular even multiple compressible layers and woven fabric layers between carrier layer 4 and cover layer 7. Thus, for example, the sequence of intermediate layers 5 and 6 may repeat one more time or several times.

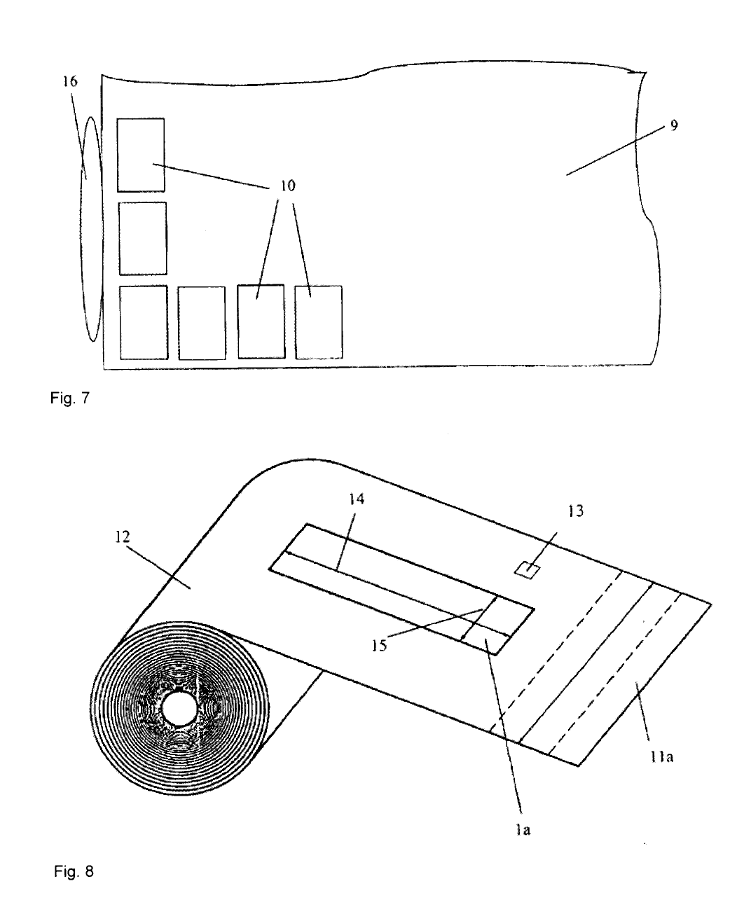

A printing couple according to the invention for a web-fed printing press has a plate cylinder 16 with a printing plate 9, which bears at least 96 printed pages 10. This is depicted only in part in FIG. 7. The printing plate 9 in this case is still shown in a state in which it is not yet firmly clamped to the plate cylinder 16. In this case, a single printing plate may preferably be provided which bears the total of at least 96 printed pages. As an alternative, multiple printing plates 9 could also be provided on the plate cylinder 16, which bear a total of 96 pages. A single printing plate is preferred for reasons related to minimizing complexity.

Also a part of the printing couple according to the invention are a printing blanket cylinder 8 according to FIG. 5 with a printing blanket 1, comprising at least one inner carrier layer 4, a first intermediate layer designed as a woven fabric layer 6 and an outer cover layer 7, wherein the woven fabric layer 6 comprises warp threads 2 and weft threads 3. As FIG. 5 shows, the printing blanket is fastened on the printing blanket cylinder 8 such that the warp threads 2 extend in the axial direction A of the printing blanket cylinder 8 and the weft threads 3 extend in the circumferential direction of the printing blanket cylinder 8.

To produce a printing blanket 1 according to the invention as described above, it is provided that a printing blanket section 1a intended as a printing blanket 1 is removed from a printing blanket material web 12 as depicted in FIG. 8 in such a way that the expansion of the printing blanket section la in the longitudinal direction 14 of the printing blanket material web 12 is greater than the expansion in the transverse direction 15 of the printing blanket material web 12. The printing blanket section 11a would in contrast yield a printing blanket 11 according to the prior art, i.e., section 11a shows the previously conventional method of producing printing blankets 11.

The section 13 of the printing blanket material web 12 corresponds to the depiction in FIG. 1, which shows this section with the corresponding cross sections enlarged. In this case, one can clearly see how the warp threads 2 run in the longitudinal direction 14 of the material web 12 and the weft threads 3 run in the transverse direction 15 of the material web 12.

1.-6. (canceled)

7. A printing blanket, comprising:
an inner carrier layer;
an outer cover layer; and
a woven fabric layer disposed between the inner carrier layer and the outer cover layer, wherein the woven fabric layer includes warp threads and weft threads, and wherein the warp threads extend in an axial direction of a printing blanket cylinder and the weft threads extend in a circumferential direction of a printing blanket cylinder.

8. The printing blanket according to claim 7, wherein the warp threads extend in an axial direction of the printing blanket and the weft threads extend in a circumferential direction of the printing blanket.

9. The printing blanket according to claim 7, wherein the woven fabric layer is more expandable in a direction of the weft threads than in a direction of the warp threads.

10. The printing blanket according to claim 7, wherein the inner carrier layer is a metal layer or a plastic layer or a woven fabric layer.

11. The printing blanket according to claim 7, further comprising a compressible layer disposed between the inner carrier layer and the woven fabric layer.

12. A printing couple for a web-fed printing press, comprising:
a plate cylinder with a printing plate which has at least 96 printed pages; and
a printing blanket cylinder with a printing blanket, wherein the printing blanket comprises an inner carrier layer, an outer cover layer, and a woven fabric layer disposed between the inner carrier layer and the outer cover layer, wherein the woven fabric layer includes warp threads and weft threads, and wherein the warp threads extend in an axial direction of the printing blanket cylinder and the weft threads extend in a circumferential direction of the printing blanket cylinder;
wherein the printing blanket is a sleeve-shaped printing blanket and is radially extensible such that the printing blanket may be slid onto the printing blanket cylinder by a radial expansion of the printing blanket and such that the printing blanket may be shrunk onto the printing blanket cylinder by a lessening of the radial expansion.

13. A method for producing a printing blanket for a printing blanket cylinder, comprising the steps of:
removing a printing blanket section from a printing blanket material web such that the printing blanket section is more expandable in a longitudinal direction of the printing blanket material web than in a transverse direction of the printing blanket material web.
